(19) United States
(12) Patent Application Publication
(10) Pub. No.: US 2010/0269718 A1
(43) Pub. Date: Oct. 28, 2010

(54) Rotary Printing Press With Synchronization Of The Folding Drive Assembly

(75) Inventor: Harold Meis, Burgthann (DE)

Correspondence Address: KREMBLAS & FOSTER, 7632 SLATE RIDGE BOULEVARD, REYNOLDSBURG, OH, 43068, US

(73) Assignee: BAUMULLER ANLAGEN-SYSTEMTECHNIK GMBH & CO. KG, Nurnberg (DE)

(21) Appl. No.: 12/754,649

(22) Filed: Apr. 6, 2010

(30) Foreign Application Priority Data
Apr. 24, 2009 (EP) 09 158 747.7

(51) Int. Cl. B41F 5/00; G06F 3/12

(52) U.S. Cl. 101/216; 358/1.15

(57) ABSTRACT

Method for the synchronization of one or more drives of a folding unit of a printing press that processes weblike objects with additional drives of the printing press, in that these first drives are synchronized in a common communication link (Sercos ring) on a common command axis, wherein one or more second drives are operated in the printing press outside of the communication link (Sercos ring), each of which is provided with a transmitter input and synchronized on the command axis of the communication link (Sercos ring) such that position transmitter and/or velocity transmitter and/or acceleration transmitter signals are generated depending on synchronous setpoint values of the command axis in the communication link (Sercos ring) and furnished as setpoints to the respective transmitter inputs of the second drive or drives.

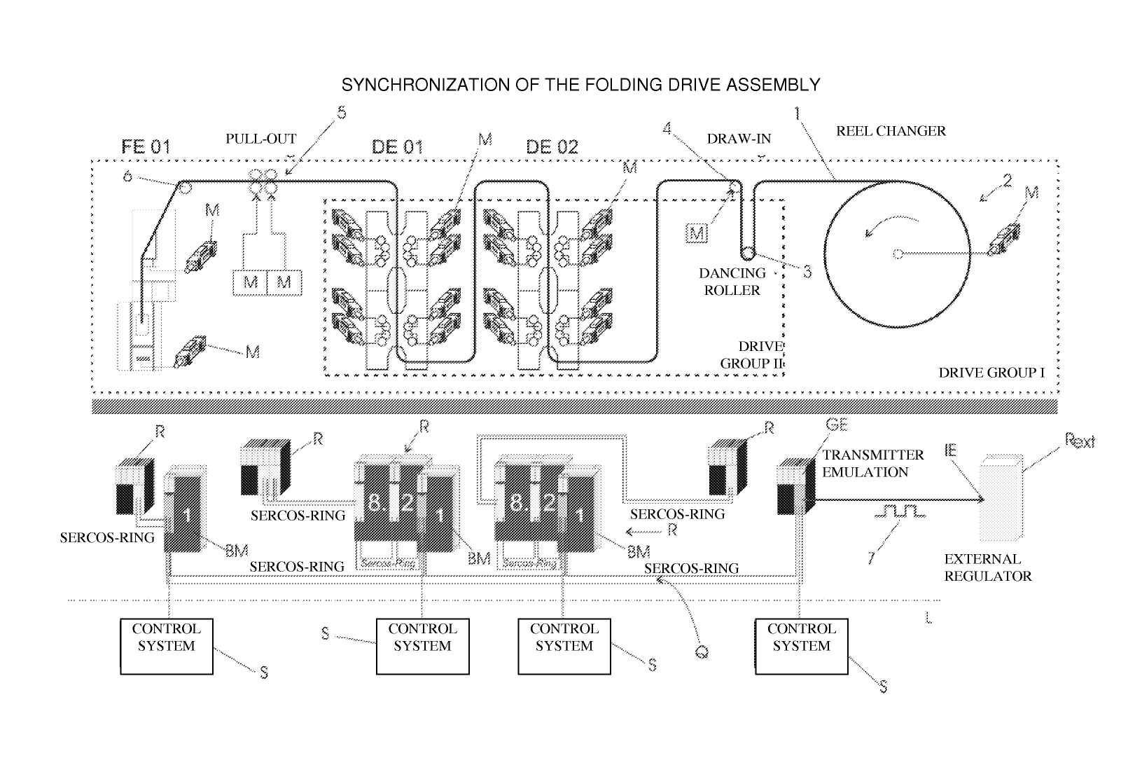

### BACKGROUND OF THE INVENTION

(1) Field of the Invention

The invention concerns a method for the synchronization of one or more drives of a folding unit of a printing press that processes weblike objects with additional drives of the printing press. The synchronization occurs in that these drives (both the one for the folding unit and also other functional components of the printing press) are synchronized via a common, preferably real-time-capable communication link, such as on in a star or ring structure (the latter known, for example, as a SERCOS ring) or some other field bus, on a common command axis, possibly dictated by a higher-level control system. The communication link, such as a real-time field bus, has for example a star or ring structure (the latter known, for example, as a SERCOS ring). Moreover, the invention concerns a rotary printing press with at least one folding unit, wherein the functional units of the printing press besides the folding unit can be moved by several first drives, which are the nodes in a common communication network.

(2) Description of the Related Art

In rotary printing presses, the functional components such as folding unit, printing cylinder of the printing unit, etc., are generally operated by individual electric drives. These have to be synchronized to each other to interact in register-true manner, so that the printing products can be produced in the required quality. As a rule, the synchronization is accomplished by a common command axis, dictated by a higher-level control system, by means of which the individual drives are individually oriented in position and speed. The synchronization through the command axis must generally include the sheet folding apparatus or folding unit of the printing press. That is, the functional components of the printing press that are in physical contact with the generally weblike object, such as the folding unit with spider wheel and knife cylinder, web draw-in and pull-out mechanisms, reel changer, etc. (the so-called “folding drive assembly”) have to be moved by a certain offset in order to achieve a synchronization by the higher-level command axis.

EP 1 772 263 A1 teaches how to integrate all individual drives that are driven mechanically independently of each other, including those of the folding apparatus, draw-in mechanism, reel changer, and other traction rolls, into ring-shaped real-time buses with cross communication as a communication system, in order to accomplish a synchronization with each other by transmitting a synchronizing clock generated in higher-level control systems. Thus, the folding apparatus, starting from an initial condition, will be synchronized on a command axis as its drives adjust to setpoint values of the command axis that are relayed by the real-time bus. Furthermore, it is specified that auxiliary units transporting into the folding apparatus or the folding unit, such as the draw-in or pull-out mechanism or the like, execute movements that are synchronized in position and speed for the moving of the folding unit during its synchronization. Yet with the concept presented in EP 1 772 263 A1 it is necessary for all drives, including those assigned to the auxiliary folding units or the reel changer, to be configured for the data communication in the ring-shaped real-time bus, which heightens the requirements for communications intelligence of the drive components used and, thus, their procurement costs.

### SUMMARY OF THE INVENTION

The basic problem of the invention is to increase the configuration flexibility in a rotary printing press with synchronization of the folding drive assembly. For the solution, refer to the synchronization method indicated in claim 1 and the rotary printing press indicated in the independent claim 6. Advantageous, optional embodiments of the invention will emerge from the dependent claims.

According to the invention, still other drives are arranged and operated outside the communication link or network in the printing press, especially a rotary printing press (so-called “second drives”). In selecting the drive components for them, one is not limited to compatibility with the communication network. The requirements on communication capability of the drive components and thus their costs are advantageously reduced. It is important that the second drives each have a transmitter input, especially an incremental transmitter input, which is almost always available in standard drives.

According to a second feature of the invention, synchronous command axis setpoint values are directly or indirectly derived or picked off from the communication link or network or at least from a drive synchronized by it, and transformed into pulse sequences or analogous signal forms, which correspond to the output signals of a position, velocity and/or acceleration sensor, such as an incremental transmitter, resolver, or a Ferrari acceleration sensor. In this way, one achieves the benefit of compatibility with the respective standard transmitter input of drive components that are commercially available, and the latter can be synchronized at slight expense on the command axis along with the drive link connected in via the communication network.

According to one optional embodiment of the invention, the transmitter signals for the second (“external”) drives of the printing press are generated with a real sensor, which is coupled to a real axle, such as a rotating shaft, of one of the first drives working in the communication link. This real sensor can be, for example, a “real” incremental transmitter. The corresponding output signal of the sensor, especially an incremental transmitter, which contains the synchronizing assignment of the command axis setpoints, can be easily fed into a standard transmitter input of the second drives built from regular drive components.

Alternatively or in addition, one or more transmitter emulators are placed in connection by communication techniques with regulators or other nodes of the first drives that are working and communicating with each other in the communication link or network in order to generate transmitter-like signals. The transmitter emulator(s) can then receive data at the input which contains synchronizing command axis setpoint values. In the course of the emulation, these values are artificially converted into transmitter or sensor-like output signals for the particular standard transmitter input.

In essence, the invention opens up the possibility of tying in drive units that are not contained in the communication link for the synchronization of the folding drive assembly (all drives or assemblies that are in contact with the product web). It becomes possible to tie in or integrate these “second” drives and assemblies in the synchronization movement of the folding drive assembly.

According to an especially advantageous embodiment of the invention, the basic principle of the invention can be applied to the reel changer of a printing press: in the above described prior art (EP 1 772 263 A1) the reel changer drive must belong to the category of “first” drives, namely, it is part of the drive interconnection linked up via the communication network. Alternatively, the reel changer could be controlled in relation to the web tension or the unwinding of the product web by a familiar dancing roller. This kind of regulation can be viewed as a P-regulator (proportional regulator). But this kind of regulation comes with the drawback that there first always needs to be a deviation in order for a manipulated variable to arise. On the contrary, the invention proposes deriving transmitter signals from the drive and/or communication linkage of the first drives, for example, copying them by transmitter emulation on the basis of the synchronizing setpoint values of the command axis and furnishing them to a customary standard transmitter input of the reel changer drive.

### BRIEF DESCRIPTION OF THE DRAWING

Further details, features, combinations (and subcombinations) of features and effects based on the invention will emerge from the following description of a preferred sample embodiment with the help of the drawing. This shows in the single FIGURE
a schematic block diagram with accompanying equipment diagram of a sample embodiment of the invented synchronization system for the folding drive assembly.

### DETAILED DESCRIPTION OF THE INVENTION

According to the single FIGURE, in a rotary printing press in familiar fashion the weblike object or product web 1 being processed is transported from a reel changer 2 across a dancing roller 3 to regulate the mechanical tension of the product web, across a pull-in roller 4 or other pull-in mechanism, across two or more printing units DE01, DE02 (such as printing towers, each with eight rubber cloth and eight plate cylinders and eight paired-up drive motors M), across a pull-out mechanism 5 with several coordinated drive motors M and across a deflection roller 6 into a folding unit FE01 with accompanying drive motors M, such as those for knife cylinder, spider wheel, etc. There is a drive regulator R assigned to each drive motor M, being interconnected with each other in familiar fashion in communication linkages in the form of, say, ring-shaped real-time field bus systems with cross communication Q. Such communication rings are available on the market, for example, under the brand “SERCOS”. On a higher-level command and control layer L there reside several control units S, which for the most part or at least partially communicate with a drive regulator R, designed as a bus master BM, of a respective SERCOS drive and communication ring. Via the respective bus masters BM, which receive synchronizing command axis setpoint values such as velocity and/or acceleration setpoint values from the higher-level command and control layer L, and via the cross communication ring bus Q, these synchronizing command axis setpoint values are distributed to additional bus masters of other local SERCOS rings and also to a transmitter emulator GE, which is likewise hooked up to the SERCOS ring bus for the cross communication Q and communicates with its own dedicated control unit S.

Not contained in the SERCOS communication rings is an external drive regulator Rₑₓₜ, which controls the drive motor for the reel changer 2. The reel changer 2 with its drive Rₑₓₜ, A belongs to a drive group I, which includes the drives of the assemblies/functional components that are in contact with the paper or product web 1 (draw-in roller 4, pull-out mechanism 5 and folding unit FE01, and possibly other ones). The other drive group II includes, along with the accompanying drives R, M, the printing units DE01, DE02 which are still in a preproduction phase in the “print off” setting, and not yet in the “print on” setting, i.e., not yet in contact with the product web 1.

With the method of the invention it is essentially possible to also synchronize drives not tied into a SERCOS communication ring during the synchronization of the folding unit FE01. To reduce waste paper, the folding unit FE01 must be positioned in the shortest possible time in a synchronized position relative to the command axis. For this, all functional components of the drive group I, i.e., those in contact with the paper or product web 1, must be displaced at an identical speed relative to the product web. This is certainly possible for the drives R, M that are brought together in the SERCOS communication rings and thus are accessible by communication techniques for synchronizing command axis setpoint values. Other drives not tied into the SERCOS communication ring, such as the reel changer 2 with its dancing regulating system 3 in the sample embodiment, are accessible only indirectly and not via the SERCOS communication rings for the command axis setpoint values.

For this, as shown by the sample embodiment drawing, one utilizes the fact that almost all drives on the market have an incremental transmitter input IE, which can also be used for assigning setpoints by circuitry and/or software means. In the present case, the transmitter emulator GE is tied into the SERCOS cross communication ring or branch Q (part of the Sercos ring communication network) as an assembly for generating incremental transmitter signals, and this also serves to synchronize the folding unit on the command axis. Consequently, this cross communication ring Q can also be used by the transmitter emulator to receive synchronizing command axis setpoint values, transform them into corresponding pulse-train track signals typical of incremental transmitters (see, for example, EP 1 311 934 B1), and furnish them to the external drive regulator Rₑₓₜ of the reel changer 2 residing outside the communication linkage. The pulse tracks 7 simulated by the transmitter emulator and typical of incremental transmitters are then synchronous with the command axis setpoint values for the folding unit FE01.

With the principle illustrated by this sample embodiment it is fundamentally possible to make synchronous setpoint assignments even for external drives which are not integrated in a synchronous communication link and to synchronize them on the same command axis that prevails in the communication link. If not for this, the “second” drives not tied into the communication link would be left out of the synchronization process, such as the folding synchronization with drives/assemblies/functional components in contact with the web. With the invention's proposed tying in by generating of transmitter signals based on the command axis setpoint values, or the transmitter emulation GE in the depicted sample embodiment, the functional components not tied in, along with their drives, such as the reel changer 2, can immediately follow the synchronization movement when a command axis setpoint is assigned to the first drive units R,M located in the communication link. In particular, the above sample embodiment avoids too large a deviation and the associated danger of paper tearing in connection with the dancing roller regulation.

### LIST OF REFERENCE NUMBERS

1 Product web
2 Reel changer
3 Dancing roller
4 Draw-in roll
DE01 Printing unit
DE02 Printing unit
M Drive motor
5 Pull-out mechanism
6 Deflection roller
FE01 Folding unit
R Drive regulator
Q Cross communication
L Command and control layer
S Control unit
BM Bus master
GE Transmitter emulator
Rₑₓₜ External drive regulator
IE Incremental transmitter input
7 Emulated transmitter signal

1. A method for the synchronization of one or more drives (R,M) of a folding unit (FE01) of a printing press that processes weblike objects (1) with additional drives (R,M) of the printing press, in that these first drives (R,M) are synchronized in a common communication link (Sercos ring) on a common command axis, characterized by one or more second drives (Rext,M) being operated in the printing press outside of the communication link (Sercos ring), each of the second drives being provided with a transmitter input (IE) and synchronized on the command axis of the communication link (Sercos ring) in that transmitter signals are generated depending on synchronous setpoint values of the command axis in the communication link (Sercos ring) and furnished as setpoints to the respective transmitter inputs (IE) of the second drive or drives (Rext,M).

2. A method according to claim 1, characterized in that, to generate the transmitter signals, a real axle of one of the first drives (R,M) operating in the communication link (Sercos ring) is sampled by a sensor for position, speed, or acceleration, and the corresponding sensor output signal is furnished to one or more of the second drives (Rext,M) as a setpoint.

3. A method according to claim 1, characterized in that, to generate the transmitter signals (7), a transmitter emulator (GE) is coupled to the command axis in the communication link, whose output signals (7) are furnished to one or more of the second drives (Rext,M) as setpoints.

4. A method according to claim 1, characterized by at least some of the first and second drives (R,M; Rext,M) being brought into contact with the common weblike object (1) at the same time during the folding synchronization process.

5. A method according to claim 1, characterized by some of the drives (R,M) or the printing press functional components moved by them, especially printing units (DE01, DE02) or printing cylinders, are kept out of contact with the weblike object (1) during the folding synchronization process.

6. A rotary printing press with at least one folding unit (FE01) as one of functional units that can be moved by several first drives (R,M), which are nodes of a common communication network (Sercos ring), by which the first drives (R,M) are synchronized on a common command axis, characterized by one or more second drives (Rext,M) each provided with a transmitter input (IE), which are arranged outside of the communication network (Sercos ring), wherein a transmitter signal generator (GE) is coupled to at least one of the first drives (R, M) or the command axis inside the communication network (Sercos ring), being connected at its output to the transmitter input(s) (IE) of the second drive(s) (Rext,M), which are configured by software or circuitry to use the transmitter input (IE) for synchronized assigning of setpoints.

7. A rotary printing press according to claim 6, characterized by the transmitter signal generator is designed as a position, velocity, and/or acceleration sensor and coupled to a real axle of one of the first drives (R,M) operating in the communication network (Sercos ring), and a corresponding sensor output signal is furnished to the transmitter input(s) (IE) of the second drive(s) (Rext,M).

8. A rotary printing press according to claim 6, characterized by a transmitter emulator (GE) being a node of the common communication network (Sercos ring) to receive command axis setpoints and to generate position transmitter or velocity transmitter or acceleration signals (7) in dependence on the command axis and it is connected by its output to transmitter inputs (IE) of the second drive(s) (Rext,M).

9. A rotary printing press according to claim 8, characterized by the transmitter emulator (GE) is coupled to a cross communication branch (Q) of the communication network (Sercos ring), especially for the purpose of receiving command axis setpoint values, and/or to a higher-level control unit (S).

10. A rotary printing press according to claim 9, wherein a reel changer (2) is connected to a second drive (Rext,M) operated outside the communication network (Sercos ring), characterized by the transmitter signal generator (GE) being connected by its output to the reel changer drive (Rext,M) or its transmitter input (IE).
